(19) United States
(12) Patent Application Publication
(10) Pub. No.: US 2013/0198151 A1
(43) Pub. Date: Aug. 1, 2013

(54) METHODS FOR FILE SHARING RELATED TO THE BIT FOUNTAIN PROTOCOL

(71) Applicant: STMICROELECTRONICS S.R.L., Agrate Brianza (IT)

(72) Inventors: Alexandro SENTINELLI, MILANO (IT); Andrea Lorenzo VITALI, BERGAMO (IT)

(73) Assignee: STMICROELECTRONICS S.R.L., Agrate Brianza (IT)

(21) Appl. No.: 13/748,057

(22) Filed: Jan. 23, 2013

(30) Foreign Application Priority Data
Jan. 27, 2012 (IT) VI2012A000026

(51) Int. Cl. G06F 17/30

(52) U.S. Cl. CPC G06F 17/30289
USPC 707/693

(57) ABSTRACT

An embodiment relates to distributing media over a peer-to-peer network by employing a digital fountain coding. Accordingly, the file is separated into file portions and the portions are combined to obtain encoded portions which are then transmitted. A file portion may form a part of a plurality of the encoded and transmitted file portions. The portions may be pieces and/or blocks of the file, wherein a piece includes a plurality of blocks. An embodiment further provides mechanisms for efficient block-request-transmission approaches in which the initial requests for blocks in the file are transmitted and additional requests for some random blocks are transmitted. The additional requests may be transmitted after each piece or after the entire file blocks have been requested, or both.

### PRIORITY CLAIM

The instant application claims priority to Italian Patent Application No. VI2012A000026, filed Jan. 27, 2012, which application is incorporated herein by reference in its entirety.

### TECHNICAL FIELD

An embodiment relates to techniques for distributing media contents. In particular, an embodiment relates to distributing media files in a peer-to-peer network.

### BACKGROUND

When using the Internet or any other multi-user data network, one of the most challenging tasks is to transmit to a single user, or more users, high amounts of data which may also be delay sensitive.

Typically, data networks support connectionless Internet Protocol (IP) on the network protocol layer. On the transport protocol layer, basically two protocols may be employed: transmission control protocol (TCP) and user data protocol (UDP). The TCP provides mechanisms for retransmissions, flow control, and congestion control. In contrast, UDP does not provide any means for reliable delivery apart from providing cyclic redundancy check (CRC) for detecting transmission errors. The usage of TCP protocol is connected with higher complexity due to re-transmission mechanism, flow control, and congestion control mechanisms. Its usage is further connected with higher delays resulting from retransmissions of the erroneously received or missed packets. File sharing applications such as File Transport Protocol typically made use of the TCP. A TCP connection is established from a TCP client to a TCP server and a file is transferred from the server to the client in the form of packets, i.e., portions of the file data. If a packet is detected at a receiver as missing or corrupt, it is retransmitted. The UDP has been typically used for real-time services for which no retransmission mechanisms are feasible. For instance, video streaming of voice over IP are usually transported over UDP.

Another approach to file sharing is peer-to-peer (P2P) file sharing. Accordingly, a user downloads media (files with text data, audio or video information or any other application data) using a P2P client, which at first searches for other computers coupled to the network, and downloads the data from the found computer(s). It has become possible to download portions of a file from different computers in the network. Such a P2P file sharing may be implemented over UDP protocol, while the transmission reliability mechanisms are implemented by the application over the UDP. For instance, torrent-like protocols have lately emerged, which facilitate easy joining of the network and downloading portions of data from multiple computers.

The term Peer to Peer (P2P) is a network in which a part, or the entire, network functionality is implemented by peers in a decentralized way, rather than a centralized client-server architecture. A peer is typically a program that is run on a host. The same program may be run on a plurality of hosts, which are intercoupled to form a P2P network. P2P networks make use of a cumulative bandwidth of all peers, i.e., the network participants. A peer typically implements both client and server functions: it serves as a client for the host user and provides server functionality for the other network hosts/users. An important principle of the P2P networks is that the peers/hosts provide resources, including bandwidth, storage space, and computing power. Thus, as new peers arrive and the load of the system increases, the total capacity of the system also increases. The distributed nature of P2P networks also increases robustness in case of failures by replicating data over multiple peers.

The peers are typically implemented as software at the application layer. Accordingly, the entire peer-to-peer network works at the application layer wherein every end user shares his/her own contents and resources with the peers of the whole overlay. Accordingly, the community of the network users may download/upload contents in a mutual cooperation mode and grow (theoretically) indefinitely. The peer-to-peer networks are an interesting alternative for all kinds of applications. They are already widely used, especially in non-real time file sharing which enables the users to share audio files or any other files.

The file sharing in P2P systems is based upon the running of programs (peers), which are used to create and maintain a network enabling the transmission of files among users. Users can, therefore, both download files from other users of the P2P network and specify file sets in the file system of their own terminal, which are adapted to be shared with others, i.e., to be made available to other users of the P2P network. A file sharing protocol in a currently used Peer-to-Peer network adapted to distribute large amounts of data is known as BitTorrent. Beside the original client version, this protocol is available in several implementations, which are substantially analogous to, for example, aria2, ABC, BitComet, BitTornado, Deluge, Shareaza, Transmission, μTorrent, and Vuze (former Azureus).

The system is based on the use of .torrent files that include metadata information about the original file to be shared by the P2P network users and by the tracker which keeps track of the peers sharing the content. The tracker plays the role of a central entity with which peers communicate periodically (substantially through a mechanism of periodical registration), so as to be aware of one another. The tracker sends out and receives peer information and also maintains peer statistics. As for the BitTorrent clients sharing and downloading the content, at least one accesses the whole file made available by the web server for downloading. According to the current approach, the server is what the end user sees first at the moment of choosing the .torrent file.

The web server is, therefore, one of the complementary actors to be taken into consideration while implementing a P2P network. The server is one of the possible entities that distribute the metadata, i.e., the .torrent file. Every peer in the network retrieves such a file to be able to access the media content itself. The way in which the metadata is retrieved may not be previously defined. The typical case is when the peers download it from the web server (or from another equivalent server) through a normal client/server protocol. It is, however, possible to retrieve the metadata in other ways (via chat, Facebook, email, USB key, etc.). In any case, the metadata may be distributed outside the P2P network. The overall structure of a torrent file (e.g., MyFile.torrent) includes the URL of the tracker, and a dictionary or look-up (info) including the keys. A key is a name, which is suggested to indicate the informing entity. If the entity is a single file, then this key may represent a file name. If the entity includes several files, then this key may map to a directory name. Another key is piece length, which is the size of each piece of the entity, and a string (named “Pieces(*)”), which may include the concatenation of SHA1 hashes of each piece of the entity. A length key includes the length of the file in bytes. If this key is present, it means that the entity is a single file; otherwise, the “files” key will be present, with the related list of the files set. If the entity to be downloaded is a directory of multiple files, instead of a length the “files” key will be present, with the related metadata information. The files key includes a list of files and directories with the following keys: length: the length of the file in bytes; and path: a list of strings containing sub-directory names, the last string being the file name. In the case of a set of files, the directory name will be present. The .torrent files with this structure are metadata files that are created before the file or the files (i.e., the “entity”) are shared. Although they may not constitute the entity itself, .torrent files include the metadata to allow a BitTorrent client to download an entity (e.g., as already mentioned, the tracker URL, the filename, the number of pieces, etc. of the content). An advantage relating to the use of .torrent files is that they have far smaller sizes than the size of the original entity, which in the case, e.g., of media content with high resolution, may reach a size in the order of Gigabytes. The peers wishing to download an entity file must, therefore, first obtain a corresponding .torrent file and connect to the specified tracker. The latter tells them which of the other peers they can download the file pieces from. The users browse the web to find a torrent of interest, to download it, and to open it with a BitTorrent client. The client connects to the tracker or trackers specified in the .torrent file, wherefrom the client receives a list of peers currently transferring pieces of the file(s) specified in the torrent. The proper downloading process can start, with each peer sharing his upload resources and his contents in the network, by exchanging blocks also called “chunks” of the file. The peer distributing a file treats the file as a series of identically-sized pieces. The peer may create a checksum for each piece, by using any suitable checksum algorithm, as, for example, the SHA1 hashing algorithm, and records it in the metadata .torrent file. The size of the piece is the same for each piece, and may be configurable by the user when he decides to create the metadata file. In the case of a relatively large payload, it may be possible to reduce the size of a metadata file by resorting to large sized pieces, for example, larger than 512 Kbytes, but this may reduce the protocol efficiency. When another peer later receives a particular piece, the piece checksum is compared with a recorded checksum, to check that the piece is error-free. In the case of the BitTorrent protocol, the output information produced by the SHA1 algorithm is 20 bytes long and is listed in the torrent file at the field “Pieces,” so that this field is responsible for verification of the data pieces' integrity, and therefore of the integrity of the content itself. In order to increase the reliability of the transmission and optimize the global throughput of a network, coding techniques have been employed. One of the approaches is referred to as Digital Fountain (DF) coding. Digital fountain coding does not require any retransmission mechanism. The main idea of the digital fountain codes is to subdivide a file into packets and to produce encoded packets by modulo-2 summing up of a predetermined number of packets. This summing-up may be performed by employing an exclusive-or operation, i.e., by “XORing” the predetermined packets together. This approach enables receiving the portions of the file from different peers in the network and combining them at the receiving client. The packets received include several summed packets in an overlapping way so that the file may be reconstructed even if some portions of data are missing. More details on Digital Fountain coding can be found in John W. Byers, Michael Luby, Michael Mitzenmacher, and Ashutosh Rege, “A digital fountain approach to reliable distribution of bulk data,” Proceedings of the ACM SIGCOMM '98 conference on applications, technologies, architectures, and protocols for computer communication, p.56-67, Aug. 31-Sep. 04, 1998, Vancouver, British Columbia, Canada, or M. Mitzenmacher, “Digital Fountains: A Survey and Look Forward,” Information Theory Workshop, 2004, which are incorporated herein by reference.

The implementation of a digital fountain approach in P2P networks may require solving many challenges. For instance, the particular approach of the data generation has an impact on the efficiency of the coding, and thus on the throughput of the network. Moreover, the distribution of block requests in the network has an impact on the flow and congestion state of the network.

### SUMMARY

In view of the above, an embodiment is a technique of data assembling, coding, and distribution by applying the DF coding technique on a multi-layer data representation of a file. In P2P scenarios, the file is structured as file, piece, and block, thus DF can be applied on them. Such inner mechanism of data assembling, coding, and distribution can indeed be applied also to other scenarios than P2P where, for example, particular types of data structuring meet the needs of specific distribution systems.

An embodiment enables data generation including random combinations of pieces and/or blocks of the pieces.

In accordance with an embodiment, a method is provided for distributing data of a file in a peer-to-peer network, the method including the steps of: subdividing the file into input pieces and the pieces into blocks, coding the file by a digital fountain coding including at least one of: obtaining an encoded piece by combining random input pieces and dividing the encoded piece into blocks; or obtaining an encoded piece by combining random input pieces, dividing the encoded piece into input blocks, and obtaining encoded blocks as combinations of the input blocks; or obtaining an encoded block by combining random blocks from the same input piece; or obtaining an encoded block by combining random blocks from random input pieces; or obtaining an encoded block by combining random blocks from all pieces of the file, and transmitting the coded file.

It is noted that the term “random” here refers to a pseudo-random selection based on, for instance, a random generator with the seed given by the number of the block or the piece processed. However, the seed may also be set in another way. The block or piece number are beneficial since they provide means for both receiving and transmitting a seed to set the pseudo-random generator accordingly.

The transmission may be performed over a retransmission less protocol. For instance, the transmission may be performed over UDP transport layer protocol or over TCP with disabled retransmissions. However, the present disclosure is not limited thereto, and is also employable with protocols supporting retransmissions with retransmissions configured.

In accordance with another embodiment a method is provided for receiving data of a file in a peer-to-peer network, the method including the steps of: receiving blocks which are portions of the file, decoding the file by reconstructing its pieces based on linearly independent blocks, wherein the blocks and the pieces are in one of the following relations: a received piece is a combination of random pieces of the file, the received blocks form portions of the received piece; or a received block is a result of combining random blocks of pieces, which are obtained by combining random pieces of the file; or a received block is a combination of random blocks from the same piece; or a received block is a combination of random blocks from random pieces of the file; or a received block is a combination of random blocks from all pieces of the file.

A method for receiving the data according to an embodiment further includes the step of transmitting for blocks of each piece initial requests to at least one peer; and for each piece: after transmitting requests related to all blocks of a piece, transmitting additional requests for at least one block of said piece. Such an approach may be particularly beneficial for services which make continuous use of the received data such as streaming rather than waiting until the entire file is downloaded.

Alternatively or in addition, an embodiment of a method may further include the step of after transmitting initial requests related to all blocks of the file, transmitting additional requests for at least one block of each of the file pieces.

In accordance with an embodiment, the initial requests are transmitted with a high priority and at least a part of the additional requests are transmitted with a low priority.

The number of block or piece requests transmitted to a single peer may be limited to a predefined number.

In accordance with another embodiment, an apparatus distributes data of a file in a peer-to-peer network, the apparatus including: a segmentation unit for subdividing the file into input pieces and the pieces into blocks, a coding unit for coding the file by a digital fountain coding including at least one of: obtaining an encoded piece by combining random input pieces and dividing the encoded piece into blocks; or obtaining an encoded piece by combining random input pieces, dividing the encoded piece into input blocks, and obtaining encoded blocks as combinations of the input blocks; or obtaining an encoded block by combining random blocks from the same input piece; or obtaining an encoded block by combining random blocks from random input pieces; or obtaining an encoded block by combining random blocks from all pieces of the file, and a transmitting unit for transmit the coded file.

The transmitting unit may be configured to perform the transmission over a retransmission-less protocol.

In accordance with another embodiment, an apparatus for receiving data of a file in a peer-to-peer network includes: a receiving unit for receiving blocks which are portions of the file, a decoding unit for decoding the file by reconstructing its pieces based on linearly independent blocks, wherein the blocks and the pieces are in one of the following relations: a received piece is a combination of random pieces of the file, the received blocks form portions of the received piece; or a received block is a result of combining random blocks of pieces which are obtained by combining random pieces of the file; or a received block is a combination of random blocks from the same piece; or a received block is a combination of random blocks from random pieces of the file; or a received block is a combination of random blocks from all pieces of the file.

The apparatus may further include a request transmitting unit for transmitting for blocks of each piece initial requests to at least one peer; and for each piece: after transmitting requests related to all blocks of a piece, transmitting additional requests for at least one block of said piece.

Alternatively or in addition, the apparatus may further include a request transmitting unit for, after transmitting initial requests related to all blocks of the file, transmitting additional requests for at least one block of each of the file pieces.

In accordance with another embodiment, a computer program product includes a computer-readable medium having a computer-readable program code embodied thereon, the program code being adapted to carry out an embodiment.

### BRIEF DESCRIPTION OF THE DRAWINGS

The above and other features will become more apparent from the following description of one more more embodiments given in conjunction with the accompanying drawings in which:

FIG. 1 is a schematic drawing showing an example of subdivision of a file to pieces and blocks;

FIG. 2 is a schematic drawing illustrating an example of various data generation approaches based on pieces and/or blocks of file data;

FIG. 3 is a schematic drawing illustrating an example of a piece-based data generation;

FIG. 4 is a schematic drawing illustrating an example of a block-based data generation;

FIG. 5 is a schematic drawing illustrating an example of block request policies applicable to a P2P network;

FIG. 6 is a schematic drawing illustrating examples of further policies for block request transmission in a P2P network;

FIG. 7 is a flow diagram illustrating a method according to an embodiment for piece-wise transmitting of additional requests;

FIG. 8 is a flow diagram illustrating a method according to an embodiment for file-wise transmitting of additional requests; and

FIG. 9 is a block diagram illustrating a functional structure of a peer according to an embodiment.

### DETAILED DESCRIPTION

An embodiment provides an efficient approach to data generation employing the digital fountain mechanism and the block request distribution of the blocks already coded.

FIG. 1 shows an example of subdividing a file 110 into pieces 120 of file data, which are further subdivided into blocks 130 of the file data. The blocks correspond in size to the packets that are finally transported in the network. The file may be any data file such as a text file, audio file, video data file, multimedia file, or a file created by any application. The digital fountain coding may be applied to the blocks 130 or to the pieces 120. The file may also form a single piece, depending on its size. The blocks 130 here are equally sized portions of data, which are combined into pieces 120. In general, a single block 130 may be used to generate a number of pieces 120. This provides some redundancy to the transmitted data. Accordingly, even when some pieces are not received or not received correctly, the some blocks 130 of data may be reconstructed from other pieces. This, on the other hand, may enable reconstruction of the entire file 110 by using the blocks from other pieces. This approach is particularly beneficial since it enables reconstruction of missing pieces without the necessity of retransmissions. Moreover, it enables downloading different blocks and pieces from different source nodes while making use of the diversity of information distributed in the sources.

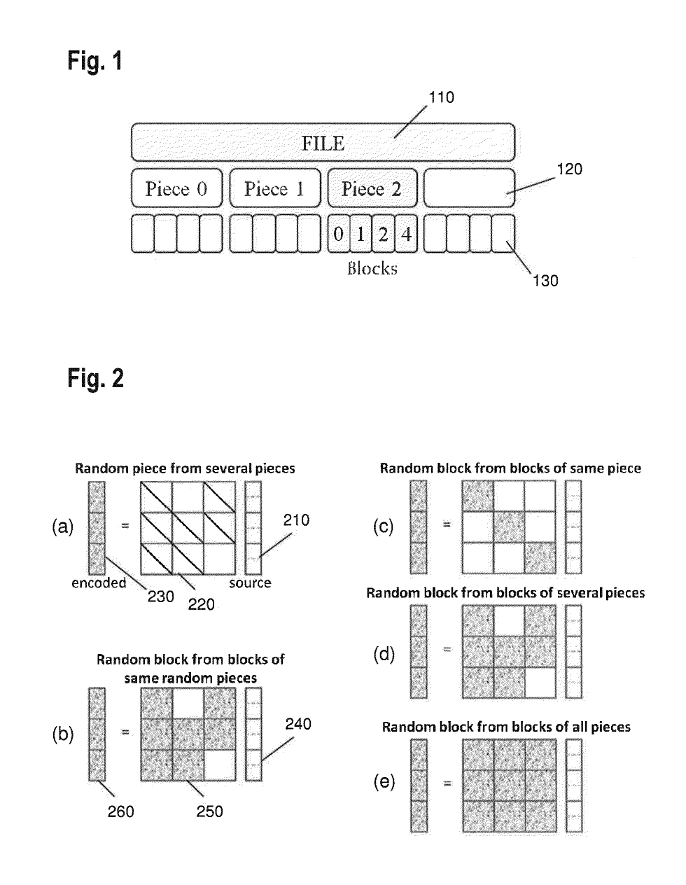

Some possibilities of applying the digital fountain coding to the data of the file 110 are illustrated in FIG. 2, in particular, in Subfigures (a) to (e). FIG. 2 illustrates a digital fountain (DF) coding matrix 220, 250 as a square of size 3×3. The DF coding matrix is applied to the source data 210, 240 to obtain DF-encoded data 230, 260.

Subfigure (a) of FIG. 2 shows a column 210 of the source data in the form of pieces (three pieces). The three source pieces are transformed by the DF coding matrix 220 into the three encoded pieces 230. Accordingly, the first encoded piece is obtained by combining the first and the third source piece; the second encoding piece is obtained by combining all three source pieces; and the last encoded piece is obtained by combining the first two source pieces.

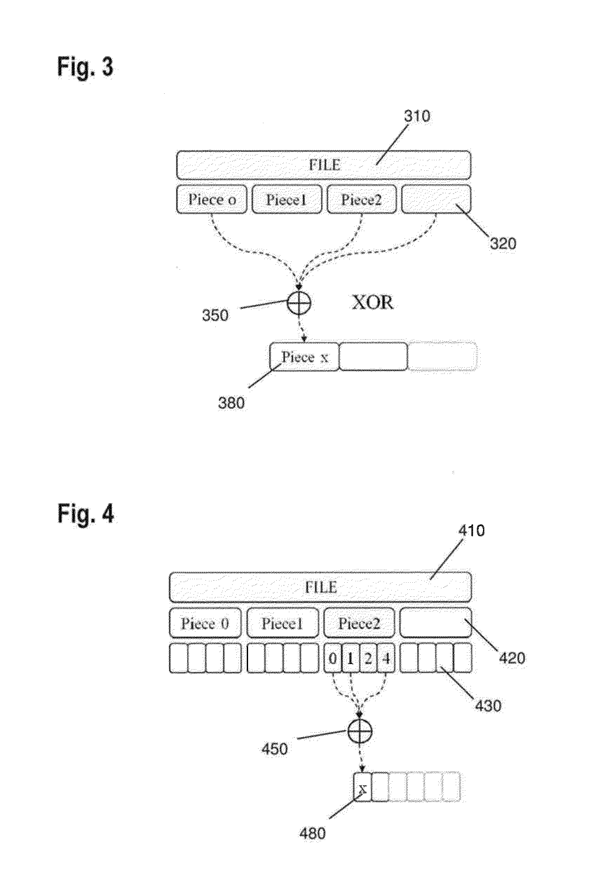

FIG. 3 illustrates such encoding in more detail. The encoded pieces 380 are formed by combining the entire pieces 320 of the source data, i.e., of the source file 310. The combining here is performed by applying the logical exclusive or (XOR) operation, i.e., by XORing. In general, however, the combining may also be performed by other logical or numerical operations. For instance, a sum or a difference may be used, or any other operation for combining the source data. Here it is assumed, that the data transmitted are binary. However, in general, the data may be handled in any numerical form such as decimal, hexadecimal, octal, or any other. FIG. 3 shows summing-up 350 the first (“piece 0”), third (“piece 2”) and fourth piece of file data to generate the encoded piece x. As can be seen, it is possible to code a piece (“piece x”) by using several other pieces. This approach will be further referred to as coding at a piece level. In other words, coding at a piece level means forming pieces as a combination of other entire pieces. The source pieces 320 coupled to the XOR in FIG. 3 are only an example and, in general, each piece may be generated by a different number of different pieces. A single source piece 320 may be used to generate more encoded pieces 380.

The idea is to apply a digital fountain encoding method to the pieces: the input file is already divided in pieces (so digital fountain is not required to split it); for every request, a digital fountain encoding method using chosen pieces as input is applied. Accordingly, digital fountain will randomly select which pieces to combine, for instance by using XOR. In this way a random piece is obtained, which has the same size as the input file pieces. Then, the random piece is sliced accordingly to the length specified in the request, obtaining a random block, which is sent to the requester.

Subfigure (b) of FIG. 2 illustrates another example, in which blocks of a piece may be coded using blocks from the same random pieces. This approach will be referred to in the following as concatenated coding at piece and then block level. Fountain codes are applied first to all data pieces, obtaining random pieces, and then the encoding is applied on all blocks within the same random piece, obtaining random blocks. One actually obtains, indeed, the same output of the case in FIG. 2 (d) but the procedure is different.

However, the DF coding may also be performed on a block basis as shown in FIG. 4 and as also illustrated in Subfigures (c) to (e) of FIG. 2. In particular, a file 401 is subdivided into pieces 420, and each piece is further subdivided into the blocks 430. The blocks 430 are then combined 450 into encoded blocks 480 to be transmitted.

A block may be coded by using random blocks of the same piece as also shown in FIG. 4. FIG. 4 shows forming of an output (encoded) block “x” by using the first (“0”), the second (“1”), and the fourth (“3”) block of the same “piece 2”. This corresponds to FIG. 2c, according to which a block is formed as a combination of randomly selected blocks from the same piece. This approach will be referred to as coding at the block level.

Alternatively, as shown in FIG. 2d, a block may be coded by using blocks from several pieces. This approach will be referred to as concatenated coding at the block level. In this case, random blocks from random pieces may be combined.

Finally, as shown in FIG. 2e, a block may be coded by using blocks from all pieces. By referring to all pieces, all pieces of the file are meant. Consequently, this option corresponds to applying the Digital Fountain to the entire file. This approach will be referred to as coding at the file level.

It is noted that the selection of blocks and pieces, from which the blocks or pieces may be combined, may be performed in a random way (for instance, by using a pseudo-random generator). However, it is also possible to combine predefined blocks from the predefined pieces, or predefined blocks from random pieces or random blocks from predefined pieces in order to obtain a block, or a piece of the encoded data. In summary, digital fountain coding subdivides a file of data into a plurality of input portions which are then combined to obtain encoded portions, wherein a same input portion may be combined into several encoded portions in order to achieve redundancy. It is further noted that the different encoded portions may be combinations of different respective numbers of the input portions. For instance, some encoded portions may be formed by three input portions, others by two or four, or any other number. However, the number of input portions to be combined may also be fixed and equal for all encoded portions. These are merely implementation issues. The number of input portions to be combined into encoded portions may also be random. It may, however also be determined in another way. The portions are blocks or pieces.

Also described is the scenario of streaming applications where the playout deadline is a fundamental constraint for a smooth experience of the end user that doesn't want to witness unexpected freeze of the video because frames are not available. The combination of the blocks or pieces, in addition to the above case, can be also implemented through a set of units that gets progressively larger. At the beginning of the session, the DF portions can be combined through a more restricted set of blocks or pieces while during the streaming session, the combination can embrace a larger set of blocks or pieces.

According to an embodiment, the peer may be configurable to employ any of the above-described data-generation approaches. For instance, the peer software may provide settings according to which a piece-oriented or a block-oriented data generation may be adopted.

At the client side, a piece is decodeable only when a sufficient number of coded blocks or pieces which are linearly independent have been received. This enables that some blocks which were not received or not received correctly may be reconstructed by the operation inverse to the combining operation. It the case of the XOR operation, another XOR operation may be used.

The transmission of the coded blocks and/or pieces over a network and the request policies applied also have an important impact on the throughput of the network. In general, a network includes a plurality of peers, which are coupled in an arbitrary manner. They may be all fully intercoupled, or there may be only a subset of all possible interconnections among them.

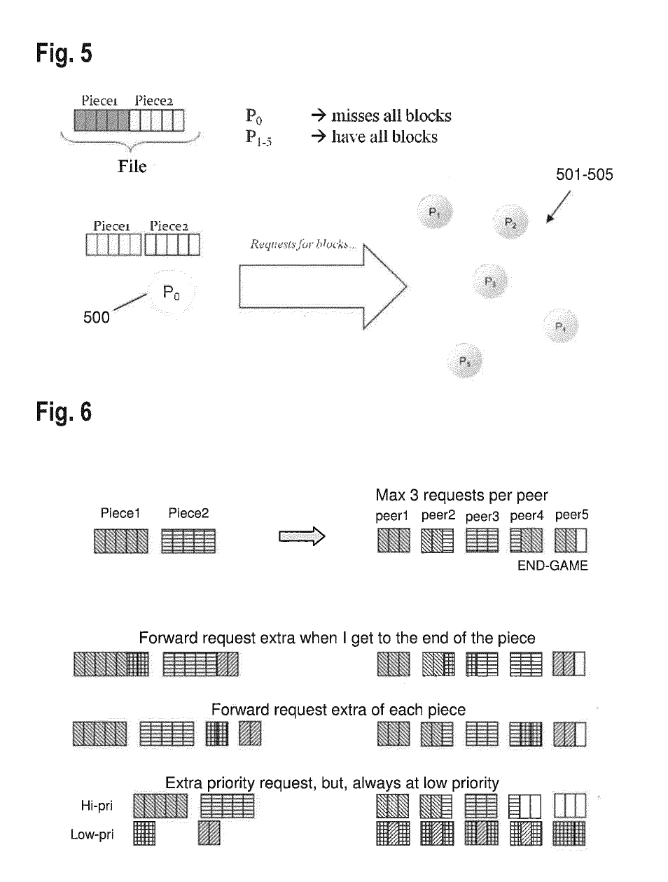

FIG. 5 illustrates a situation in which there are five peers 501 to 505 (also denoted P0 to P5) forming a peer-to-peer (P2P) network. The peer P₀ 500 enters the P2P network, where the other peers P₁₋₅ hold the whole file which is made by two pieces: “Piece1” and “Piece2”. Therefore, P₀ starts to forward the request for blocks to the peers P₁₋₅. In a typical torrent-like protocol, the entering peer cannot ask for all blocks to all peers who have the blocks. Otherwise the network will be soon congested by signaling overhead messages such as requests. Therefore, policies are set up which would enable an entering node 500 to transmit its requests without the risk of congesting the network, and, in order to improve the throughput of the network, with as little amount of signaling as possible.

FIG. 6, Subfigure 0) illustrates an exemplary policy, which limits the number of block requests per each peer. In the example of FIG. 6, the number of block requests is limited to three. Except of the policy according to which the peer P₀ can forward a maximum of 3 block requests per peer, there is another beneficial mechanism that tries to overcome the well-known problem of the “last rare chunk”. A P2P network usually relies on common resources that are shared by the very peers that have built the network (in this example, peers 501 to 505). Network congestions or peers that leave the network may affect dramatically the reliability of download. There may be various different reasons for a peer to leave the network. For instance, a computer of the peer may be turned off, or the sharing program may be closed, or the shared file may be deleted, etc. It may then happen that when the download of the file is almost complete so that only few remaining blocks are missing, those few blocks tend to trickle in rather slowly because they have been requested from slow or congested peers. Such remaining blocks are then called “last rare chunk”. Therefore, in accordance with another beneficial policy, in order to complete the download, additional copies of those blocks are requested from other peers: this technique is known as “End Game Mode” (EGM). It can be seen in FIG. 6, 0) that the last two blocks of “Piece1” have been asked initially from “Peer2” and, in addition, from “Peer4” and “Peer5”.

Bit Fountain is an implementation of a digital fountain approach which may have particularly advantageous policies for block requests such as those described herein. In particular, in accordance with an embodiment, the EGM is improved because, thanks to the DF mechanism, the peers do not ask for one specific block. All block requests are equivalent. Therefore, a higher degree of flexibility is allowed. However, it may be still beneficial to discriminate among some options of request distribution as will be described below with reference to FIG. 6.

In general, the EGM strategy means that after transmitting all requests related to the last blocks of a file, a peer issues final requests for the same remaining blocks to all its peers. When a block comes in from one peer, the requesting peer sends CANCEL messages to all the other peers to which the final requests have been sent, in order to save bandwidth. It is usually cheaper (in terms of resources) to send a CANCEL message than to receive the full block and just discard it.

The P2P network may be used for exchanging various data files. While the order of pieces/block reception does not matter for the file download of the text files or any files downloaded completely, and, after finishing the download, using the file, the order of arriving of pieces and/or blocks may be important for streaming services such as audio or video streaming, and/or desktop sharing applications. Therefore, in such scenarios, it may be important to ensure substantially ordered download of pieces of such files. Thus, the EGM may not perform optimally in these scenarios since the additional request in EGM is only sent after sending all the requests related to all the pieces to different peers. According to an embodiment, therefore, an additional request is transmitted after transmitting requests for all blocks of a single piece.

Referring to FIG. 6, Subfigure 1), when the peer P₀ forwards all block requests relative to the “Piece1”, the peer P₀ keeps asking for redundant blocks belonging to the same Piece1. The mechanism is repeated for each subsequent piece of the file. This approach helps in completing the current piece before downloading the next piece. This may be an advantageous policy, especially for streaming over P2P applications. The peer P₀ may ask all the peers for the redundant blocks. However, as discussed above, this could lead to congesting the network and/or wasting the resources. Accordingly, it may be advantageous to apply this approach together with a policy of limiting the number of requests issued for the redundant blocks, or a policy of limiting the number of requests that may be transmitted to a single peer.

In accordance with the EGM as originally suggested, the last blocks of the file are requested redundantly from all peers and a CANCEL message is transmitted as soon as the requesting peer receives all blocks. However, such an approach selectively treats the different pieces of the file: only the blocks of a last piece or pieces are redundantly received. In order to provide an alternative which may provide benefits for various applications, in accordance with an embodiment, the handling of the pieces are made more uniform. With reference to FIG. 6, Subfigure 2), when the peer P₀ forwards all block requests relative to the “Piece1” and “Piece2” that means, in fact, all the missing blocks of the file, then the peer P₀ asks for extra redundant blocks for each piece. This helps in completing the download of the file similarly to the End Game Mode. However, with this approach, the redundant requests are not specific and not directed only to the last blocks of the file. As long as the fastest peers answer by sending enough redundant data, the download is completed, and no specific CANCEL messages are needed. The budget of redundant requests can be allocated unevenly. For instance, more redundant requests may be allocated to the most incomplete pieces.

A combination of the previous two approaches described with reference to Subfigures 1) and 2) of FIG. 6 may also be beneficial. Accordingly, a given amount of redundant requests (for instance 5%) can be requested after all block requests are sent for a given piece as in the case 1). Then, a request for a next piece is sent. After all pieces have been requested, further redundant requests may as in the case 2). The further redundant request may be, for instance another 5% of the requests. It is noted that the 5% is only an example. In general, the percentage may be different for the piece-wise additional requests (case 1))) and for the final additional requests (case 2)). Moreover, the percentage may be set differently than to 5%. It may be set to 1% or 2% or 6% or 10% or any other value. This value may be configurable at the peer and/or automatically configurable at the peer based on the throughput of the network or other network parameter, and/or based on the resources available to the peer, and/or based on the application for which the file is received (streaming, file download).

Another embodiment envisages defining a level of priority for the requests. In particular, two priorities may be defined: a high and a low priority block request. In particular, the first requests for all pieces may have the high priority and the additional requests may have a low priority. With reference to FIG. 6, Subfigure 3), for each piece, the peer P₀ forwards the first block requests, which are high priority, and the low priority request that are relative to the same piece. In a logical perspective, the peer P₀ forwards in parallel the requests relative to the “Piece1” and “Piece2” but, from an implementation point of view, the requests are sent subsequently one after the other. In other words, through the introduction of the attribute “low/high priority”, the request distribution scheme has another degree of freedom. In the following, examples of this embodiment and its exemplary combinations with the previously described embodiments are provided.

In one example, the peer transmits initial requests for all blocks of a piece with the high priority and upon transmitting the requests, transmits at least one additional request for a block of the same piece. Here, the term “initial” means the first request for that block. The term “additional” means a request further to the initial request. Regarding the at least one additional request, a request for one or more blocks may be transmitted. The request or requests may be predetermined (for instance, always request the last block or last number of blocks) or random. The random additional requests may be preferred since they may provide better diversity.

In terms of FIG. 6, according to this example, the peer P₀ forwards a low-priority request of “Piece1” immediately after forwarding the high-priority requests for blocks or the entire piece “Piece1”. FIG. 6, Subfigure 3) shows this example in combination with the policy of transmitting a maximum of 3 high-priority requests to a peer.

The redundant (additional) request(s) is/are sent with the low priority. For instance, the peer can request all normal blocks as high-priority, and then it can send 100% of redundant requests as low-priority. Afterwards, it can send 5% of redundant requests as high-priority again. But both 100% and 5% are only examples, and the percentage may vary depending on the application in which an embodiment is used. Any other percentages may be employed. In general, low-priority requests may be used for transmitting more additional requests. The high-priority requests may be used to transmit the initial requests and then to transmit some additional requests. The amount of additional requests transmitted with low priority is, in an embodiment, higher than the amount of additional requests transmitted with the high priority.

Another example envisages that a peer first transmits all initial requests related to all pieces with the high priority. Then, it transmits additional requests with low priority for some or all of the blocks in all the pieces. In terms of FIG. 6, the peer P₀ forwards the low-priority requests of Piece1 and Piece2 only after having forwarded the high-priority requests of Piece1 and Piece.

Still another example envisages transmitting normal requests for all pieces, then transmitting, e.g., 20% of redundant requests at low-priority, and finally sending, e.g., 5% of redundant requests at high-priority. It is noted that the low-priority additional requests and the high-priority additional requests may overlap, i.e., both may include a request to transmit the same block. However, they may also be non-overlapping. Again, the 20% and 5% percentages are selected for exemplary purposes only and, in general, any other percentage may be applied. However, it may be advantageous to transmit more additional requests with the low priority than with the high priority.

The above-described embodiments and examples may be combined with each other. For instance, low-priority additional requests may be transmitted after each piece, and, in addition, low-priority requests may be transmitted for blocks of all pieces after transmitting initial requests for all pieces. The percentages of additional requests may be specified as also described above. Moreover, the additional requests transmitted after each piece may be sent with low priority and the additional requests transmitted after the entire file may be transmitted with a high priority or vice versa, depending on the application.

Another possibility is to send normal requests for a given piece, then send, e.g., 100% redundant requests at low-priority for the same piece, then send, e.g., 5% redundant requests at high-priority for same piece, the go to next piece and proceed in the same way. After proceeding with all pieces, send, e.g., 20% redundant requests at low-priority (budget can be allocated unevenly among incomplete pieces), then send, e.g., 5% redundant request at high-priority (budget can be allocated unevenly among incomplete pieces). The uneven allocation among the incomplete pieces means that the more incomplete the piece, the more requests may be transmitted for its blocks.

It is noted that high priority and low priority are relative terms. In general, a high priority is a first priority, a low priority is a second priority, wherein the second priority is lower than the first priority. The high/low priority may have consequences onto transmission within the network and/or processing by the peers. For instance, peers would first process requests with high priority and then requests with lower priority. Alternatively, or in addition, the bandwidth for processing the high-priority request at a peer is higher than the bandwidth to process a low-priority request. The bandwidth is the transmission bandwidth for providing the requesting node with the requested blocks.

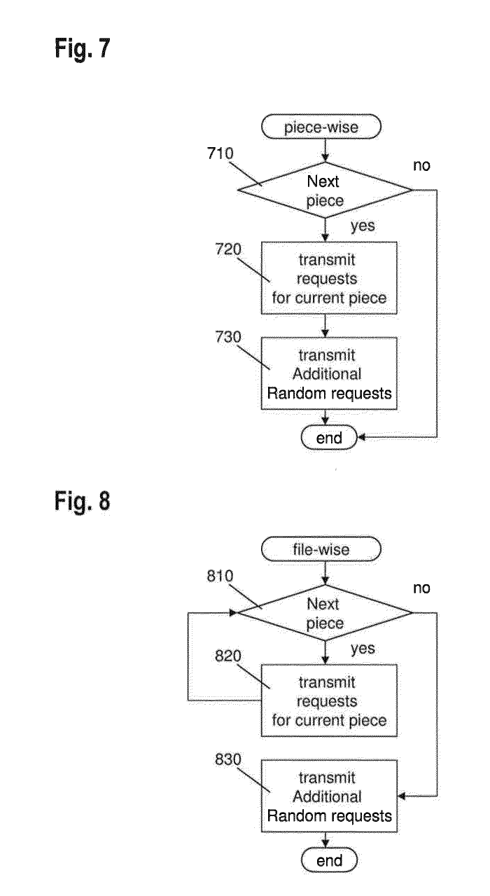

FIG. 7 illustrates a method according to an embodiment. This is the approach denoted above as “piece-wise” additional request transmitting. Accordingly, as long as there is a piece to be coded (“yes” in step 710), requests for all blocks in the piece are transmitted 720. Then, additional requests for randomly selected blocks from the same piece are transmitted. This may be also a single request for a single block. This approach is repeated for all pieces in the file. When there are no more pieces (“no” in step 710), the method terminates.

FIG. 8 illustrates an embodiment of another approach, which may be used as an alternative or in addition to the method described above with reference to FIG. 7. This approach is denoted here as “file-wise” random additional request transmission. It differs from EGM in that it randomly selects from all pieces blocks for which the additional requests will be transmitted. The additional requests are transmitted after all requests related to all pieces are transmitted. As long as there is another piece in the file (“yes in step 810), the requests to that piece are transmitted 820. When there are no more pieces (“no” in step 810), the additional requests are sent 830, for randomly selected blocks from all pieces. It is noted that the blocks may also be selected randomly from random pieces. Then the method terminates.

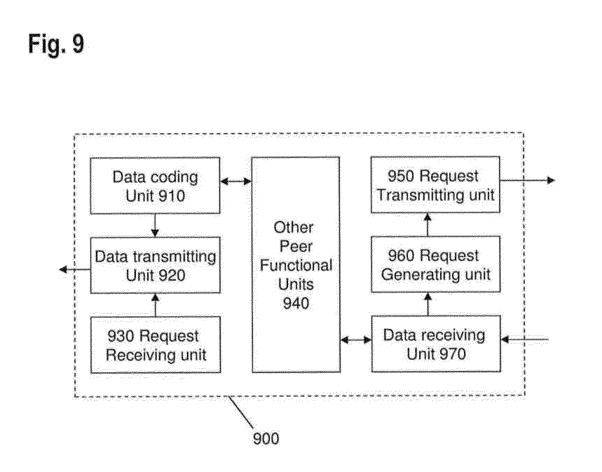

FIG. 9 illustrates an example of a functional structure of the peer 900 according to an embodiment. The peer 900 may include both a client and a server part or may also include only one of them. In particular, the client part includes the units for receiving data 970 and units for generating 960 and transmitting 950 requests for data to the other peers. The client part may further include other parts 940 typical for the peer client and which are not material for the present disclosure. They may include, for instance, data compression, storage, and/or other processing units. The server part of the peer 900 may include units for transmitting the data 920, coding the data 910, and a unit for receiving requests for transmission of data 930.

Summarizing, an embodiment provides mechanisms for a more efficient transmission of data in P2P networks. In particular, it enables, in contrast to EGM, randomizing the additional requests for blocks. The additional requests may be sent after transmitting a request for each piece and/or after transmitting requests for all pieces. The term “random” means that the blocks for which the additional requests are transmitted are selected randomly. More exact, they are selected pseudo-randomly based on a pseudo-random generator in the peer. In order to enable synchronized random selection at the requesting and the requested peer, it may be advantageous to use for the random generation the number of the block and/or piece or any other common information. For instance, the number of the block or the piece or another identification of the data transmitted may be used to set the seed of the random generator, meaning setting the initial condition of the random generator. The first requests for transmitting blocks may be transmitted with a higher priority than the additional requests. The peer to be selected for transmitting a request to it may be selected based on the speed of its response. The peers with the shortest response time may be selected first.

The Bit Fountain combines the effective use of a UDP protocol in a P2P file-sharing application, which distributes block units coded through digital fountain.

It is noted that even when the above approaches have been described with reference to a UDP protocol, they are all also employable with a TCP. In fact, the underlying layers may be insignificant for the disclosure. For some applications, UDP may provide benefit of less overhead, computational power, and delay. However, TCP may also be configured so as to provide benefits in combination with an embodiment for any applications.

In accordance with an embodiment, a method is provided for distributing data of a file in a peer-to-peer network, the method including the following steps:

dividing the file into input pieces and the pieces into blocks.
coding the file by a digital fountain, and
transmitting the coded file.
The coding includes at least one of:
Obtaining an encoded piece by combining random input pieces selected from a set of pieces and dividing the encoded piece into blocks. The set may be time-varying, in particular it may grow: at beginning the set may include only one piece, and, for example, the first, and at the end the set may include all pieces.
Obtaining an encoded piece by combining random input pieces selected from a set of pieces, by dividing the encoded piece into input blocks, and obtaining encoded blocks as combinations of input blocks selected from a set of the input blocks. It is noted that the set of pieces may be time varying, in particular it may grow, at the beginning including only one piece, such as the first piece of the file, whereas at the end it may include all the pieces. Similarly, the set of input blocks may be time varying, in particular it may grow, at the beginning including only one block, for example the first block, and at end including all blocks of the encoded piece.
Obtaining an encoded block by combining random blocks from the same input piece block selected from a set of blocks of the same input piece. It is noted that this set of blocks may be time varying, in particular it may grow, at the beginning including only one block, for example the first of the piece, and at the end including all blocks of the same input piece.
Obtaining an encoded block by combining random blocks from random input pieces, wherein the random blocks are selected from a set of blocks of random input pieces. This set may be time varying, in particular it may grow, at the beginning including only one block, for example the first of the earliest piece, and at the end including all blocks of all selected pieces. The random input pieces may also be selected from a set of pieces which may vary/grow as described above.
Obtaining an encoded block by combining random blocks from all pieces of the file block selected from a set of blocks. The set of blocks may be time varying, in particular it may grow, at the beginning including only one block, for example, the first of the first piece, at the end including all blocks of all selected pieces.

However, it is noted that the present disclosure is not limited by this embodiment and that, in general, the set of pieces and blocks does not necessarily have to include all the respective pieces and blocks at the end. Some pieces and blocks may be deleted later. The growing of the set enables encoding/processing of the file while the parts of the file are read. This may provide some advantages in timing and for parallelization.

Especially for streaming applications it may be beneficial to combine a set of blocks or pieces which changes over a timeline following different criteria. For instance:

There is an option of a variable set size for selection of combining pieces or blocks set size that changes over time and can, as an example but not limited to, become larger and larger along the session through any type of function or curve with an average increasing ascendant behavior.

Alternatively or in addition there is an option of a variable set size for selection of a same size combining pieces or blocks relative to the same content but carrying independent (such as multiple description coding) or dependent (such as scalable video coding) information that can be used for refinement, set-size changes over time and can, as an example but not limited to, become larger through the session including more content or alternatively refinement blocks or pieces for same content.

Alternatively or in addition, there is an option of a same set size of pieces or blocks of different size. Blocks and pieces, in this case, are relative to the same type of content but available at different video qualities, with different types of video encoding quality hierarchy, and each block and piece are assigned to a specific video quality layer or tag.

Any combinations of the above three options are possible. In particular, pieces and/or blocks may include portions of a coded video signal. The video signal may be coded and subdivided into parts of same importance. Alternatively, or in addition, the video signal may be encoded using a layer coding in which base layer contain the low-resolution/quality signal and the other layers refinements thereof. However, there may also be different versions of the video signal, coded with a different level of quantization.

Summarizing, variable set sizes are considered for selection of combining blocks or pieces, set size that changes through the session, following any curve or any element choice, according to the best tradeoff among Network Access cost, user minimum requirements, user experience expectations, or platform resources.

For the Digital Fountain implementation, raptor codes may be used or any other conventional codes.

Further, various embodiments may also be implemented by means of software modules, which are executed by a processor or directly in hardware. Also a combination of software modules and a hardware implementation may be possible. The software modules may be stored on any kind of computer-readable storage media, for example RAM, EPROM, EEPROM, flash memory, registers, hard disks, CD-ROM, DVD, etc.

Summarizing, an embodiment relates to distributing media over a peer-to-peer network by employing a digital fountain coding. Accordingly, the file is separated into file portions and the portions are combined to obtain encoded portions, which are then transmitted. A file portion may form a part of a plurality of the encoded and transmitted file portions. The portions may be pieces and/or blocks of the file, wherein a piece includes a plurality of blocks. An embodiment further provides mechanisms for efficient block request transmission approaches in which the initial requests for blocks in the file are transmitted and additional requests for some random blocks are transmitted. The additional requests may be transmitted after each piece or after all the blocks for the entire file have been requested, or both.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1.-15. (canceled)

16. An apparatus, comprising:
a memory configured to store a file; and
a coder configured to generate a coded portion of the file from at least two portions of the file.

17. The apparatus of claim 16 wherein the portions of the file include pieces of the file.

18. The apparatus of claim 16 wherein the portions of the file include blocks of the file.

19. The apparatus of claim 16 wherein the portions include blocks of pieces of the file.

20. The apparatus of claim 16 wherein the coder is configured to generated the coded portion of the file by exclusive-or'ing together the at least two portions of the file.

21. The apparatus of claim 16, further comprising a segmenter configured to divide the file into a set of portions that includes the at least two portions.

22. The apparatus of claim 16, further comprising a selector configured:
to select the at least two portions of the file from a set of file portions; and
to provide to the coder the selected at least two portions of the file.

23. The apparatus of claim 16, further comprising a selector configured:
to select pseudo-randomly the at least two portions of the file from a set of file portions; and
to provide to the coder the pseudo-randomly selected at least two portions of the file.

24. The apparatus of claim 16 wherein the coder is configured to generate the coded portion of the file in response to a request for the at least two portions of the file.

25. The apparatus of claim 16, further comprising a transmitter configured to send the coded portion of the file to a requester in response to a request from the requester for the at least two portions of the file.

26. A method, comprising:
receiving a request for at least two portions of a file; and
generating a coded portion of the file from the requested at least two portions of the file.

27. The method of claim 26 wherein generating the coding portion includes combining the at least two portions of the file together to generate the coded portion.

28. The method of claim 26, further comprising:
wherein receiving the request for the at least two portions of the file includes receiving the request from a network peer; and
transmitting the coded portion of the file to the network peer in response to the request for the at least two portions of the file.

29. A tangible computer-readable medium storing instructions that, when executed by a computing apparatus, cause the computing apparatus or another apparatus under the control of the computing apparatus:
to generate a coded portion of a file from at least two portions of the file; and
to transmit the coded portion of the file in response to a request for the at least two portions of the file.

30. An apparatus, comprising:
a receiver configured to receive a coded portion of a file; and
a decoder configured to generate at least two portions of the file from the coded portion of the file.

31. The apparatus of claim 30 wherein the coded portion of the file includes a combination of the at least two portions of the file;

32. The apparatus of claim 30 wherein the at least two portions of the file include pieces of the file.

33. The apparatus of claim 30 wherein the at least two portions of the file include blocks of the file.

34. The apparatus of claim 30 wherein the at least two portions of the file include blocks of pieces of the file.

35. The apparatus of claim 30 wherein the at least two portions of the file include uncoded portions of the file.

36. The apparatus of claim 30, further comprising a file generator configured to form the file from the at least two portions of the file.

37. The apparatus of claim 30, further comprising:
a transmitter configured to transmit a request for the at least two portions of the file to a network peer; and
wherein the receiver is configured to receive the coded portion of the file from the network peer.

38. The apparatus of claim 30, further comprising:
a transmitter configured to transmit a request for the at least two portions of the file to network peers; and
wherein the receiver is configured to receive the coded portion of the file from at least one of the network peers to which the transmitter transmitted the request.

39. The apparatus of claim 30, further comprising:
a transmitter configured to transmit requests for the at least two portions of the file to network peers, at least one of the requests having a first priority, and at least another one of the requests having a second priority that is lower than the first priority; and
wherein the receiver is configured to receive the coded portion of the file from at least one of the network peers to which the transmitter transmitted at least one of the requests.

40. The apparatus of claim 30, further comprising:
a transmitter configured to transmit simultaneously requests for the at least two portions of the file to network peers, at least one of the requests having a first priority, and at least another one of the requests having a second priority that is lower than the first priority; and
wherein the receiver is configured to receive the coded portion of the file from at least one of the network peers to which the transmitter transmitted at least one of the requests.

41. The apparatus of claim 30, further comprising:
a transmitter configured:
to transmit a first request for the at least two portions of the file to a first network peer, and
to transmit, after transmitting the first request, a second request for the at least two portions of the file to a second network peer; and
wherein the receiver is configured to receive the coded portion of the file from one of the first and second network peers.

42. A method, comprising:
receiving a coded portion of a file; and
decoding the coded portion of the file into at least two portions of the file.

43. The method of claim 42, further comprising forming the file from the at least two portions of the file.

44. The method of claim 42, further comprising:
transmitting a request for the at least two portions of the file to a network peer; and
wherein receiving the coded portion of the file includes receiving the coded portion of the file from the network peer.

45. The method of claim 42, further comprising:
transmitting a request for the at least two portions of the file to network peers; and
wherein receiving the coded portion of the file includes receiving the coded portion of the file from at least one of the network peers to which the request was transmitted.

46. The method of claim 42, further comprising:
transmitting requests for the at least two portions of the file to network peers, at least one of the requests having a first priority, and at least another one of the requests having a second priority that is lower than the first priority; and
wherein receiving the coded portion of the file includes receiving the coded portion of the file from at least one of the network peers to which at least one of the requests was transmitted.

47. The method of claim 42, further comprising:
transmitting a first request for the at least two portions of the file to a first network peer;
transmitting, after transmitting the first request, a second request for the at least two portions of the file to a second network peer; and
wherein receiving the coded portion of the file includes receiving the coded portion of the file from one of the first and second network peers.

48. A tangible computer-readable medium storing instructions that, when executed by a computing apparatus, cause the computing apparatus or another apparatus under the control of the computing apparatus:
to receive a coded portion of a file; and
to decode the coded portion of the file into at least two portions of the file.
